(19) United States
(12) Patent Application Publication
(10) Pub. No.: US 2008/0250652 A1
(43) Pub. Date: Oct. 16, 2008

(54) SELF LOCKING KNIFE AND SHEATH

(75) Inventor: Brian Fellhoelter, Lake Isabella, CA (US)

Correspondence Address: DARBY & DARBY P.C., P.O. BOX 770, Church Street Station, New York, NY, 10008-0770, US

(73) Assignee: Great American Tool Co., Buffalo, NY (US)

(21) Appl. No.: 12/056,932

(22) Filed: Mar. 27, 2008

Related U.S. Application Data
(60) Provisional application No. 60/910,900, filed on Apr. 10, 2007.

(51) Int. Cl. B26B 3/06

(52) U.S. Cl. 30/164

(57) ABSTRACT

A knife and sheath that includes a spring element as part of the handle with a pin that engages a slot in the sheath so as to lock the knife and sheath together. The knife and sheath are unlocked by biasing the spring element towards the center line of the knife, thereby disengaging the pin from the slot.

### BACKGROUND OF THE INVENTION

The present invention relates to a self locking knife and sheath.

In knives that are not foldable or retractable, the blade permanently extends outwardly from the handle. Since knife blades typically have at least one sharp edge and/or point, the knife blade is usually kept within a sheath or other protective item that permits the knife to be safely carried by the user. One concern is that the knife must be easily removed from the sheath, preferrably with a single hand. On the other hand, the knife should not be capable of accidentally dislodging from the sheath, which can cause injury or loss of the knife.

Various methods have been proposed in the past for locking a knife into a sheath. For instance, in U.S. Pat. No. 2,391,574, a spring arm is riveted to the blade with the handle of the knife having a cutout portion. A locking pin on the end of the spring arm extends outwardly to engage a notch in the head of the scabbard to provide a lock. As another example, U.S. Pat. No. 4,558,516 discloses an abutment that extends from the sheath to engage a shaped hole in the knife. As yet another example, U.S. Pat. No. 5,123,167 shows a flared flexible member that is part of and in the same plane of the knife handle which engages a notch in the sheath.

### SUMMARY OF THE INVENTION

It is an object of the present invention to provide a knife and sheath combination that is simple to use, easy to manufacture and assemble but also securely holds the knife in the sheath.

In one embodiment, a spring element with a profile on the end engages a cutout section of the sheath. In particular, the spring element compresses as the knife is inserted into the sheath because of a second edge, and then the spring element causes the profile to engage with the first edge to hold the knife in place.

In another embodiment, the spring element is integral to the handle, with a pin on the end of the spring element for engaging the cutout section of the sheath.

As apparent, the invention will allow for secure carrying of the knife in adverse conditions such as whitewater, SCUBA, rescue, police and military situations, and the like.

### BRIEF DESCRIPTION OF THE DRAWINGS

FIG. 1 is a cross section view of the combination of the knife and sheath;

FIG. 2 is a cross section view of a second example of the combination of the knife and sheath;

FIG. 3 is a plan view of the knife;

FIG. 4. is a side view of the knife;

FIG. 5 is a plan view of part of the sheath;

FIG. 6 is a plan view of a second part of the sheath;

FIG. 7 is a plan view of part of the second example of the sheath; and

FIG. 8 is a plan view of a second part of the second example of the sheath.

### DETAILED DESCRIPTION OF THE INVENTION

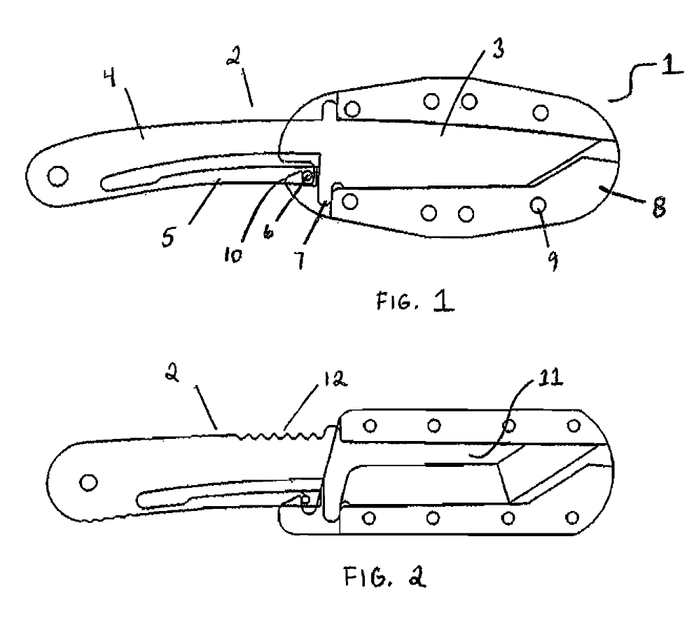

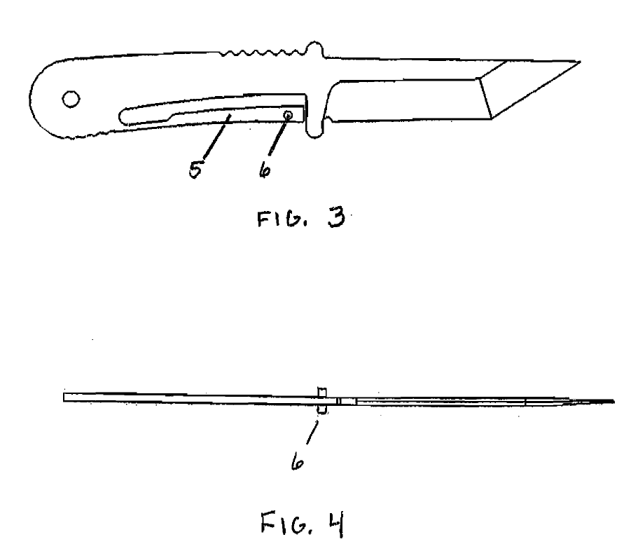

The combination of knife and sheath of the present invention is shown in FIG. 1. Combination knife and sheath 1 is comprised of knife 2 and sheath 8.

Knife 2 is comprised of blade 3, handle 4, and optionally knife hilt 7. In one embodiment, handle 4 has a cutout region which forms leaf spring 5. On the end of leaf spring 5 is mounted pin 6, which is perpendicular to and projects outside of the plane of the blade. In an alternative embodiment, leaf spring 5 may be a separate piece that is attached to the knife. Likewise, pin 6 may be inserted into or alternatively integral with leaf spring 5. In another embodiment, pin 6 may not be a pin at all, but a protrusion that is integral to the spring itself. Leaf spring 5 is shaped so as to permit biasing of its end, where pin 6 is located, toward the center line of knife 2.

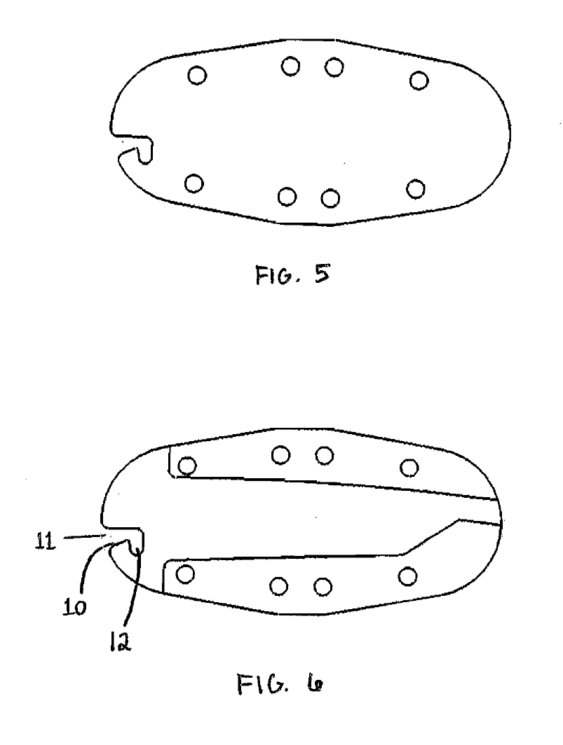

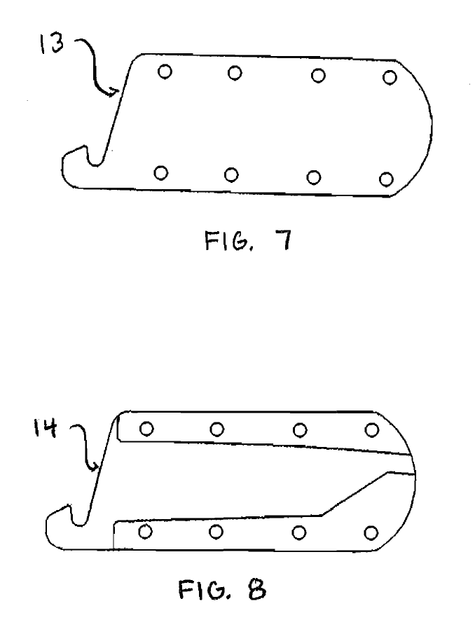

In one embodiment, sheath 8 is comprised of two pieces (shown in FIGS. 5 & 6, and alternatively in FIGS. 7 & 8) that are connected together such that a cavity is formed for holding knife 2. In one embodiment, the two pieces are connected together with screws or rivits placed in holes 9. Any number of suitable methods for connecting two pieces of a sheath may be used. Alternatively, the sheath can be made of a unitary material, or from a number of pieces. The sheath can be made from any suitable material, such as metal, plastic, hardened rubber or the like.

Sheath 8 includes slot 11 (FIG. 6) that is designed to engage or catch pin 6 when the knife is inserted into sheath 8 to hold the knife in the sheath. Slot 11 is shaped roughly in the form of a capital L, but with the vertex of the angle being typically less than 90 degrees. Thus, edge 10 is typically not parallel to the long axis of the knife and sheath, but rather at an angle. The purpose for the off axis angle is so that when the knife blade is inserted into the sheath, pin 6 will engage edge 10 to deflect pin 6 and leaf spring 5 inwardly towards the central axis of the blade. Once the pin releases from edge 10 when the knife is close to being completely inserted into the sheath, leaf spring 5 will cause the pin to be biased outwardly into cutout 12. Since pin 6 is held in cutout 12 by leaf spring 5, knife 2 will be held in sheath 8. In other words, the part of the slot that captures the pin/boss is roughly perpendicular to the axis of insertion of the knife to the sheath, while the part of the slot that runs along the axis of insertion is on an angle forcing the spring to compress as it is inserted.

When the knife is inserted into its final carry position, the notch design in the sheath keeps the knife in place until the spring is compressed again and the knife pulled out. To remove the knife from the sheath, leaf spring 5 must be moved towards the central axis of the knife blade, thereby moving pin 6 out of cutout 12. As the knife blade is moved out of the sheath, pin 6 may engage with edge 10 to push or bias the blade out of the sheath. As apparent, an alternate embodiment of the present invention may be a locking mechanism that acts, after release, to push the blade out of the sheath. Such a design can be accomplished by extending the length of edge 10.

The combination of pin 6 and slot 11 for holding the knife within the sheath can be located on either or both sides of the knife blade, or can have varying orientations and configurations. The sheath is designed to be attached to a person or object. For example, it may be attached to a belt, PFD, body armor, or the like. Thus, the sheath may contain a clip, belt loop or other device to hold it in place.

Sheath 8 can be made in various shapes. For instance, as shown in FIGS. 5 through 8, the two pieces of sheath 8 can have different configurations for the profile located nearest to the hilt of the blade, such as by having cutaway sections 13 and 14. The embodiment showing a knife inserted into such a sheath is shown in FIG. 2. The knife blade can also have other characteristics, such as surface 12 for permitting easier gripping of the blade during use.

This particular system would lend itself to retaining various other items in a sheath.

What is claimed is:

1. A combination knife and sheath comprising:
a knife having a blade and a handle;
the handle having a first end and a second end, with the second end connected to the blade;
the handle further having a spring element extending from the first end and ending proximate the second end;
the spring element having a profile extending perpendicular to the plane of the blade;
a sheath shaped to receive the blade of the knife;
the sheath having a notch located outside the plane of the blade when the knife is within the sheath, with the notch having a first edge that engages the profile of the spring element to hold the knife within the sheath until the spring element is biased to release the profile from the first edge.

2. The combination knife and sheath of claim 1 wherein the spring element is integral with the handle.

3. The combination knife and sheath of claim 1 wherein the notch further comprises a second edge at an angle less than perpendicular to the first edge and configured to engage the profile of the spring element to bias the spring element towards a center line of the knife blade when the knife is inserted into the sheath.

4. The combination knife and sheath of claim 1 wherein the profile is a pin.

5. The combination knife and sheath of claim 3 wherein the second edge acts to bias the knife out of the sheath after the profile of the spring disengages from the first edge.

6. A combination knife and sheath comprising:
a knife having a blade and a handle;
the handle having a resilient element with a protrusion on the end, with the protrusion being generally perpendicular to the plane of the blade;
a sheath having a detent outside of the plane of the blade that engages the protrusion of the resilient element when the knife is inserted into the sheath.

7. The combination knife and sheath of claim 5 wherein the resilient element is integral with the handle.

8. The combination knife and sheath of claim 5 wherein the detent is shaped so as to bias the resilient element towards a center line of the blade when the knife is inserted into the sheath.

9. The combination knife and sheath of claim 8 wherein the detent is shaped to contain the protrusion until the resilient element is biased towards the center line of the blade by a user when the user is removing the blade from the sheath.

10. A combination knife and sheath comprising:
a knife having a blade and a handle;
the handle having a biasing element with a pin;
a sheath having a slot with a sloped edge that engages the pin and causes the biasing element to flex towards the center line of the knife when the knife is inserted into the sheath and an edge perpendicular to the center line of the blade which engages the pin to hold the knife within the sheath when the knife is placed substantially within the sheath.

11. The combination of knife and sheath of claim 10 wherein the sloped edge is shaped to cause biasing of the knife away from the sheath when the knife being removed from the sheath by a user.

12. The combination of knife and sheath of claim 10 further comprising a means for attaching the sheath to an object.
